(19) United States
(12) Patent Application Publication
(10) Pub. No.: US 2026/0078878 A1
(43) Pub. Date: Mar. 19, 2026

(54) Valve Assembly, Pressure Vessel System, Motor Vehicle, and Method for Producing a Pressure Vessel System

(71) Applicant: Bayerische Motoren Werke Aktiengesellschaft, Muenchen (DE)

(72) Inventors: Daniel BAER, Garching (DE); Timo GUTMANN, Bad Kohlgrub (DE); Joerg HENNECKE, Haar (DE)

(21) Appl. No.: 19/109,606

(22) PCT Filed: Aug. 18, 2023
(86) PCT No.: PCT/EP2023/072793

§ 371 Date: Mar. 7, 2025

(30) Foreign Application Priority Data
Sep. 9, 2022 (DE) 10 2022 123 005.8

(51) Int. Cl. F17C 13/04

(52) U.S. Cl. CPC F17C 13/04; F17C 2205/0134; F17C 2205/0332; F17C 2205/037; F17C 2221/012; F17C 2270/0168

(57) ABSTRACT

A valve assembly for installation on a pressure vessel has a valve body with a first fuel line and includes a connection component with a first portion and a second portion. The valve body is secured to the first portion in a non-destructively releasable manner, and the second portion is designed to protrude at least partly into the pressure vessel when the valve assembly is installed on the pressure vessel. A second fuel line formed in the connection component runs through the first and second portions and is designed to fluidically connect an inner region of the pressure vessel to the first fuel line when the valve assembly is installed on the pressure vessel. Also described is a pressure vessel system for a motor vehicle, a motor vehicle, and a method for producing the pressure vessel system.

### BACKGROUND AND SUMMARY

The technology disclosed herein relates to a valve assembly for assembling on a pressure vessel, to a pressure vessel system having a valve assembly of this type, to a motor vehicle having the pressure vessel system, and to a production method for the pressure vessel system.

Pressure vessel systems for storing fuel in a vehicle (in particular a land craft, watercraft or aircraft) are known as such. It is also known for pressure vessels of pressure vessel systems of this type to be provided with so-called on-tank valves (OTV) which are in each case screwed into an opening of the pressure vessel. On-tank valves of this type can have a shut-off valve which enables the respective pressure vessel to be closed in such a way that no fuel from the interior region of the pressure vessel escapes through the opening. However, when the shut-off valve is opened, the fuel can flow through the on-tank valve and a retrieval line in the direction of a drive apparatus of the motor vehicle.

It is a preferred object of the technology disclosed herein to minimize or eliminate at least one disadvantage of a known solution, or to propose an alternative solution. It is in particular a preferred object of the technology disclosed herein to provide a valve assembly which is efficient in terms of installation space, is comparatively easy to assemble on a pressure vessel, and enables efficient maintenance. Moreover, it is a preferred object of the technology disclosed herein to provide a corresponding pressure vessel system, a corresponding motor vehicle, and a corresponding production method for a pressure vessel system. Additional preferred objects may be derived from the advantageous effects of the technology disclosed herein.

This/these object/s may be achieved by the subject matter of the independent claims. The dependent claims represent preferred design embodiments.

Proposed according to one aspect here is a valve assembly which is provided for installation on a pressure vessel, in particular a motor vehicle pressure vessel for fuel. The valve assembly comprises a valve body having a first fuel line, and a connection component having a first portion and a second portion. The valve body is fastened to the first portion so as to be releasable in a non-destructive manner. The second portion, in an installed state of the valve assembly on the pressure vessel, is specified to protrude at least in portions into the pressure vessel. A second fuel line formed in the connection component extends through the first portion and the second portion and, in the installed state of the valve assembly on the pressure vessel, is disposed for the purpose of fluidically connecting an interior region of the pressure vessel to the first fuel line. A shut-off valve which preferably can close the first fuel line can be provided on the first fuel line.

Therefore, the valve assembly is able to be produced and installed on the pressure vessel comparatively fast and in a cost-effective manner. Due to the design of the valve assembly in multiple parts, it is the connection component, which de facto acts as an adapter piece between the valve body and the pressure vessel, that can first be installed on the pressure vessel, in particular screwed into the latter. In a further assembling step, the valve body can then be fastened to the connection component. According to the present technology, this fastening is reversible so that, if required, for example during maintenance of the valve assembly or of a pressure vessel which will be explained hereunder and comprises the valve assembly, the connection component can remain installed on the pressure vessel, and only the valve body can be removed, replaced and/or repaired. In this way, costs in terms of maintenance and material consumption can be reduced.

Moreover, the valve assembly synergistically offers the possibility of subjecting the pressure vessel with the connection component installed thereon, and without the valve body, to safety checks which would not readily be possible in the case of a valve assembly without two parts that are able to be separated in a non-destructive manner, for example. Consequently, the valve assembly can be more precisely examined. Moreover, in the event of a defect on the valve body, in particular on the shut-off valve, only the valve body (optionally with the shut-off valve) can for example be replaced without disassembling the connection component from the pressure vessel.

In the context of the present disclosure, the term “line” (for example in the word “fuel line”), according to its general definition in the field of the present technology, describes a line device for the purpose of transporting fluids. The first/second fuel line can, for example, contain at least one (line) duct, at least one pipeline, and/or at least one hose, or be designed as such. The first fuel line is preferably formed (only) in the valve body, and the second fuel line is preferably formed (only) in the connection component. In general terms, the first/second fuel line in the present case can form a first or second fuel flow path, respectively, which can be formed by the at least one pipeline or the at least one duct. The duct can be provided in the valve body, or in the main body of the connection component, respectively, wherein the valve body/main body can in each case be designed as a valve block.

The valve body is preferably flanged to the connection component, i.e. connected to the connection component by way of a flange. For this purpose, at least one flange, which is fastened to the respective other element (i.e. to the valve body, or to the connection component, respectively), can in each case be formed on the connection component and/or on the valve body. A first flange can in particular be formed on the valve body. Alternatively or additionally, a second flange can be formed on the connection component. The first flange and the second flange can be disposed separately of one another, and/or on mutually opposite ends of the connection component. A transition between the first fuel line and the second fuel line can lie so as to be centric between these two ends, for the purpose of improved sealing.

In order for the valve body to be able to be removed from the connection component in a non-destructive manner, the connection between the valve body and the connection component can preferably be designed so as not to be materially integral, but rather force-fitting and/or form-fitting. The valve body is preferably screwed to the connection component, in particular by way of the first and/or the second flange. A first connection part having a first thread can penetrate the first flange and engage with the connection component. Furthermore, a second connection part having a second thread can penetrate the second flange and engage with the valve body. The first flange and the second flange can extend parallel to one another and extend away in opposite directions from a central part of the main body of the connection component, the second fuel line extending through that central part.

The valve body and the connection component are preferably designed in such a way that, when they are fastened to one another, they conjointly form an integral (single-piece) body, wherein main surfaces of the valve body and of the connection component extend so as to be flush with one another. The connection component can thus have a first surface on its side that lies opposite the second portion. A second surface which is formed on the valve body on the side that lies opposite the second portion preferably extends parallel to the first surface. The first surface and the second surface are preferably co-aligned.

The second portion of the connection component can be designed as a first port which (in particular by way of its longitudinal axis) can extend away from the first portion transversely, in particular perpendicularly, to a main plane of the first portion. The main plane of the first portion here can extend so as to be coplanar with a main plane of the valve body. A length of the first port is preferably smaller than a thickness of the first portion of the connection component measured perpendicularly to its main plane. In other words, the first port preferably protrudes from the first portion of the connection component to an extent that is smaller than the thickness of the first portion. The first port preferably serves to engage in an opening formed on the pressure vessel, in particular on an axial end of the pressure vessel, when the valve assembly is installed on the pressure vessel. In particular, the first port can engage in an axial, preferably metallic, end portion of the pressure vessel (so-called boss), most preferably without penetrating the latter.

The first port is preferably provided with a thread (for example an external thread), by way of which the connection component in the installed state is screwed into the pressure vessel, in particular into the boss. Accordingly, an additional thread (for example as an internal thread) that corresponds to the thread can be formed on the boss. Moreover, the first port can have on its external circumferential face a groove which is formed to be encircling. An O-ring, optionally in combination with an additional support ring for the O-ring, by way of which the second fuel line is sealed in relation to the environment of the connection component, can be disposed in the groove.

In a similar way, the valve body can be fluidically connected to the connection component. For this purpose, a port (hereunder a second port) can also be formed on the valve body. The connection component can have a receptacle which corresponds to the second port and into which the second port protrudes, and in which the second port is received in a sealing manner. As opposed to the first port, the second port is preferably designed without a thread (i.e. without a thread provided for the connection between the valve body and the connection component), because the fastening of the valve body to the connection component is preferably implemented by way of the flange(s), as described above. The first fuel line preferably extends through the second port and ends at the second fuel line which opens into the receptacle. The second port can likewise be provided with a groove which extends circumferentially (along the external circumferential face of the second port). In a manner analogous to the first port, an O-ring, optionally in combination with a support ring for the O-ring, can be disposed in the groove of the second port, for the purpose of sealing.

When the valve body is fastened to the connection component by way of the at least one flange, a longitudinal axis of the second port can extend transversely, in particular perpendicularly, to a main plane of the flange. For example, when the first flange is fastened to the connection component, in particular screwed to the latter, the second port can be inherently pushed into the receptacle. Each longitudinal axis mentioned in this disclosure can be a central longitudinal axis of the respective element/portion. Furthermore, the longitudinal axis of the second port preferably extends parallel to, or in, the main plane of the valve body. This can contribute toward the valve body resisting comparatively high pressures while being of a compact, rather thin construction mode. Consequently, the longitudinal axis of the first port can extend perpendicularly to the longitudinal axis of the second port, and establish a cross-sectional plane through the valve body and the connection component. This cross-sectional plane can extend perpendicularly to the above-mentioned first and/or second surface.

The first and the second fuel line conjointly form a fuel flow path, along which fuel from the pressure vessel can flow through the valve assembly up to a retrieval connector for a fuel retrieval line. In the connection component, the second fuel line preferably has a first end in the first portion, and second end in the second portion, wherein the first end is disposed closer to the valve body than the second end. The receptacle can be formed on the first end, so that the first end in terms of a fuel retrieval flow is a downstream end of the second fuel line. Correspondingly, the second end can be an upstream end of the second fuel line, and face the interior region of the pressure vessel.

Preferably, the second fuel line on the first end extends in a first direction, and on the second end extends in a second direction, wherein the first direction and the second direction are different, and are preferably aligned so as to be mutually perpendicular. This means that the second fuel line does not extend rectilinearly through the connection component, but is bent in the latter. Accordingly, the valve assembly can better fit into a comparatively narrow installation space on the axial end of the pressure vessel. Therefore, a pressure vessel system having the valve assembly can be integrated so as to be efficient in terms of installation space into a narrow peripheral region of a comparatively flat installation space in the underfloor region of the motor vehicle.

The connection component is preferably conceived to be connected directly (mechanically and fluidically) to exactly one pressure vessel. An additional fluidic connection of the connection component to other pressure vessels can be formed indirectly by way of distributor line connected to the connection component. In a preferred variant, the connection component can thus comprise a connector for the distributor line, which is fluidically connected to the second fuel line. Moreover, the connection component can be provided with an (in particular thermal) pressure relief device which is preferably fluidically connected to the second fuel line.

Accordingly, it can be provided that a distribution flow path leading to a connector for the distributor line, and/or a pressure relief flow path leading to a pressure relief device, branch(es) off from the second fuel line in the connection component. The distribution flow path and the pressure relief flow path preferably branch off from the second fuel line in particular at the same location, but in different directions. This location can be a location where the second fuel line is bent, and/or a location wherein the main plane of the connection component intersects the longitudinal axis of the first port. The distribution flow path and the pressure relief flow path can preferably extend parallel to a common plane, most preferably parallel to the main plane of the connection component.

There are preferably not valves or other devices suitable for controlling the flow rate of fuel provided in the second fuel line, in the distribution flow path and/or in the pressure relief flow path. Accordingly, the second fuel line, the distribution flow path, or the pressure relief flow path, respectively, can be conceived to permanently conduct the fuel. Consequently, pressurized fuel from the distributor line and/or from the pressure vessel can for example make its way to the pressure relief device substantially at any time during the intended use of the valve assembly, so as to be reliably discharged.

Apart from the pressure relief device, there is most preferably no additional valve formed on the connection component. All other valves of the valve assembly can preferably be provided (in functional sub-assemblies) on the valve body. It goes without saying that the pressure relief device can be specified to relieve pressure. The pressure relief is a procedure by way of which the pressure in the pressure vessel is reduced due to an event. The event is in particular not the retrieval according to the intended use for the purpose of supply an energy converter, but in particular a failure. The pressure relief can commence by at least partially opening a valve (for example as a consequence of a burst bursting element). If a failure occurs due to a malfunction of any other component and/or by an external thermal and/or mechanical influence (e.g. accident, local flame, etc.), the pressure relief device is specified to reduce the pressure in the pressure vessel system, in particular in the at least one pressure vessel. According to the intended use, the pressure relief device can be specified to enable a fuel retrieval mass flow for relieving the pressure in the pressure vessel, the fuel retrieval mass flow being greater (e.g. by at least a factor of 1.5, 2, 5, 10, 100) than the maximum fuel retrieval mass flow through the first fuel line.

It has been said that the pressure relief device can be a thermal pressure relief device (TPRD, also referred to as thermal safeguard or thermally triggered safety valve). Due to its position on the connection component, the thermal pressure relief device is disposed close to the pressure vessel and can thus be advantageously triggered with great precision when there is a risk of thermal damage to the pressure vessel. The thermal pressure relief device can be correspondingly conceived to be triggered in the event of heat acting thereon (e.g. due to a flame in the environment of the connection component) so as to discharge the fuel flowing from the at least one pressure vessel though the pressure relief flow path into the environment.

The pressure relief device can be fastened in an additional receptacle formed therefor in the main body of the connection component. A longitudinal direction of this receptacle for the pressure relief device can extend transversely, in particular perpendicularly, to the longitudinal direction of the receptacle for the second port, as well as transversely, in particular perpendicularly, to the longitudinal direction of the first port. An outlet of the pressure relief device, which is designed for discharging the fuel, can be aligned in such a manner on an opening of the main body of the connection component that the fuel to be discharged can flow through the opening out of the connection component. An outflow direction of this fuel is preferably parallel to the main plane of the connection component, perpendicular to the longitudinal direction of the first port, and/or parallel to the longitudinal direction of the second port.

The valve body is preferably provided with a plurality of functional sub-assemblies for controlling one or a plurality of flows through the valve body. One of these sub-assemblies can be the shut-off valve mentioned. Further functional sub-assemblies may be: a filling connector by way of which fuel from a filling line can flow into the valve body during filling of the pressure vessel; a discharge valve by way of which fuel from the pressure vessel can be discharged into the environment of the valve assembly; at least one solenoid valve on the first fuel line; and/or a retrieval connector by way of which the fuel from the at least one pressure vessel can exit the valve body in the direction of a drive apparatus of the motor vehicle. In the case of an open shut-off valve, all these functional sub-assemblies can be fluidically connected to an end of the first fuel line that is proximal to the valve body.

The shut-off valve (also referred to as tank shut-off valve) is preferably a valve which is to be manually activated. It can be disposed for the purpose of establishing a fuel flow between the connection component and the valve body, in particular of preventing fuel flowing from the connection component into the valve body. During the intended use of the valve assembly, the shut-off valve can however be open and thus be referred to as a normally open valve. The shut-off valve preferably has a valve member which is displaceable (in particular on a thread) parallel to the main plane of the valve body, preferably perpendicularly to the longitudinal axis of the first port and/or perpendicularly to the longitudinal axis of the second port. The valve member is disposed for the purpose of being displaced, preferably against a seal seat that is formed as part of the valve body, so as to close the first fuel line. In a particularly compact design embodiment, the first fuel line correspondingly has a change of direction (for example a bend and/or a kink) in the region of the seal seat of the shut-off valve. This means that an opening formed on the seal seat can be part of the first fuel line.

While the first fuel line is able to be closed by way of the shut-off valve, the second fuel line in the connection component can be designed so as not to be able to be separately closed (in particular to be free of any valve). When viewed along a retrieval flow path commencing at the pressure vessel and leading to the fuel retrieval line, the shut-off valve can be the first valve downstream of the pressure vessel. Accordingly, the shut-off valve can be the valve of which the input pressure corresponds (substantially) to the vessel pressure. If the shut-off valve is electro-mechanically activatable, it can preferably be a controllable, or feedback-controllable valve, in particular a valve which is closed when non-energized.

The retrieval connector for the fuel retrieval line is disposed on an end of the first fuel line that lies opposite the connection component. A solenoid valve is preferably provided on the first fuel line, in particular between the shut-off valve and the connector. The solenoid valve and the shut-off valve can in particular be connected in series (logically). The solenoid valve can be specified to establish a fuel flow through the retrieval connector for the fuel retrieval line. Accordingly, the solenoid valve can be the last valve on the valve body that is passed by the fuel along the retrieval flow path, before the fuel flows out of the valve assembly.

Moreover, a fuel filling path which extends from a filling connector of the valve body to the connection component can be formed in the valve body. The fuel filling path may be able to be blocked (shut-off) by way of the shut-off valve. The filling connector can be designed for connecting the filling line and can preferably have a thread for this purpose. Moreover, a check valve which can suppress a return flow of fuel from the valve body into the filling line can be provided on the filling connector. The fuel filling path preferably opens into the first fuel line between the shut-off valve and the solenoid valve.

Moreover, a fuel discharge path by way of which the first fuel line can be fluidically connected to the discharge valve for discharging fuel into the environment of the valve body can be formed in the valve body. The fuel discharge path can branch off from the first fuel line at a location of the latter where the fuel filling path opens into the first fuel line. Accordingly, a bore extending rectilinearly through the valve body can at least in portions form part of the fuel filling path as well as the fuel discharge path in such a way that the valve body is easy to produce. This bore can be closed by way of the discharge valve. The discharge valve can have a discharge opening for discharging the fuel from the at least one pressure vessel. According to the intended use, the discharge valve can be provided for establishing a fuel flow through the discharge opening. It is also conceivable that the discharge valve is designed as a pressure control valve.

The valve body and/or the main body of the connection component are preferably formed in each case without joints (monolithic). In particular, the valve body and the main body can in each case be formed from a solid block. The valve body, or the main body, respectively, can in each case be manufactured, preferably by subtractive machining, from a semi-finished product from the solid block. Subsequently, the functional sub-assemblies can be provided on the valve body, or on the main body, preferably screwed into them, respectively. In this way, the valve body and the first portion of the connection component can be formed with the same thickness at least in portions, in particular at the boundary area between the connection component and the valve body (in terms of the main plane), so as to increase the efficiency of the valve assembly in terms of installation space. The boundary area herein can extend from the first flange to the second flange. When viewed along the main plane of the valve body, a contour of the valve body can correspond to a contour of the connection component at the boundary area. In this way, the valve assembly according to the present technology can be distinguished by a compact and stable construction mode.

A pressure vessel system for a motor vehicle proposed herein is preferably provided for storing pressurized feud, and comprises at least one pressure vessel and at least one valve assembly which has been described in detail above and is installed on one of the pressure vessels. The number of pressure vessels is preferably at least two, i.e. the pressure vessel systems preferably contains a pressure vessel assembly having a plurality of the pressure vessels, including a first pressure vessel and one or a plurality of second pressure vessels. Accordingly, the connection component can be installed directly on the first pressure vessel, in particular be screwed into the latter. This means that the second portion of the connection component can protrude into the first pressure vessel.

In order to fluidically connect the second pressure vessel(s) to the first and the second fuel line (and thus to the retrieval flow path), the distributor line can be connected to the connector for the distributor line, on the one hand, and to a connector of the second pressure vessel, on the other hand. If a plurality of second pressure vessels are provided, these can be fluidically connected to one another by way of the (common) distributor line. The pressure vessel system in this instance preferably contains fewer valve assemblies than pressure vessels. In a pressure vessel system having a plurality of pressure vessels, the first pressure vessel is preferably disposed peripherally.

The distributor line can in particular be provided upstream of a (high pressure) pressure reducer. The distributor line is expediently designed to resist substantially the same pressure as, or higher pressures than, the pressure vessel. The second pressure vessels can be fluidically connected directly to one another by way of the distributor line, so that the second pressure vessels in the intended state have substantially the same pressure, according to the principle of communicating pipes. In other words, the second pressure vessels are preferably connected to the distributor line without a dedicated, externally electrically activatable, shut-off valve being in each case provided between the distributor line and the second pressure vessels. Furthermore, the distributor line can comprise a plurality of separate line portions which connect in each case two adjacent second pressure vessels directly to one another.

In this way, a single valve assembly which is easy to assemble on the first pressure vessel is fundamentally sufficient for the whole pressure vessel system for filling the pressure vessels in a controlled and safe manner with the fuel, as well as to be able to correspondingly retrieve the fuel from the pressure vessels. This makes it possible to achieve savings in terms of material, costs and time in the production of the pressure vessel system and of a motor vehicle having the pressure vessel system. Furthermore, the pressure vessel system in terms of synergy can be designed in a manner that saves installation space.

The motor vehicle proposed herein can be a land craft (in particular passenger motor vehicle or a commercial vehicle), and aircraft or a watercraft. The motor vehicle comprises a pressure vessel system described in detail above, and is thus distinguished by the advantages explained above. The pressure vessel system is preferably disposed in an underfloor region of the motor vehicle, in particular between two axles. Moreover, the pressure vessel system and/or the motor vehicle can have arbitrary, in particular all, features which have been described above in the context of the valve assembly.

A production method proposed herein serves to produce the pressure vessel system mentioned, and comprises the following steps which are preferably carried out in the sequence mentioned hereunder: providing the at least one (in particular first) pressure vessel; assembling the connection component on the (first) pressure vessel; carrying out a safety check on the (first) pressure vessel; and, after the safety check, connecting the valve body to the connection component. Furthermore preferably, the shut-off valve and/or the potential additional functional sub-assemblies on the valve body can be provided before connecting the valve body to the connection component. The safety check can include, for example, subjecting the (first) pressure vessel to a pressure test in which an internal pressure of the pressure vessel is increased at least once to a predetermined value and subsequently lowered again.

In order to repair the pressure vessel system, for example in the event of a defect of one of the functional sub-assemblies, in a repair method disclosed additionally herein fuel can be discharged from the pressure vessel system, in particular through the discharge valve. Subsequently, the valve body can be removed from the connection component and be repaired, for example by replacing the defective functional sub-assembly. Thereafter, the valve body including the functional sub-assemblies can be installed on the connection component again in order to complete the repair method.

In other words, the technology disclosed herein relates to a compact valve assembly for use in a hydrogen storage installation space in the underfloor region of a passenger motor vehicle, which can alternatively be utilized for a high-voltage accumulator of an electric-battery vehicle. As opposed to OTVs that are screwed into a pressure vessel, it is possible and permissible to replace the present valve body during servicing. An adapter piece (the connection component), which is provided with a line connector by way of which additional vessels can be connected, and which additionally contains a flange interface for an actual valve assembly (the valve body having the functional sub-assemblies) is screwed into exactly one pressure vessel of a flat storage unit having a plurality of pressure vessels.

### BRIEF DESCRIPTION OF THE DRAWINGS

The technology disclosed herein will now be explained by means of the figures in which, in each case schematically:

FIG. 1 shows a valve assembly in a perspective frontal view, wherein the valve assembly is installed on a pressure vessel, and wherein a distributor line, a filling line and a retrieval line are connected to the valve assembly;

FIG. 2 shows the valve assembly from FIG. 1 in a longitudinal sectional view along a main plane of the connection component;

FIG. 3 shows the valve assembly from FIG. 1 in a cross-sectional view through the valve assembly and the pressure vessel;

FIG. 4 shows the valve assembly from FIG. 1 in a perspective rear view;

FIG. 5 shows a pressure vessel system having a plurality of pressure vessels and the valve assembly from FIG. 1;

FIG. 6 shows a motor vehicle having the pressure vessel system from FIG. 5; and

FIG. 7 shows a production method for the pressure vessel system from FIG. 5.

### DETAILED DESCRIPTION OF THE DRAWINGS

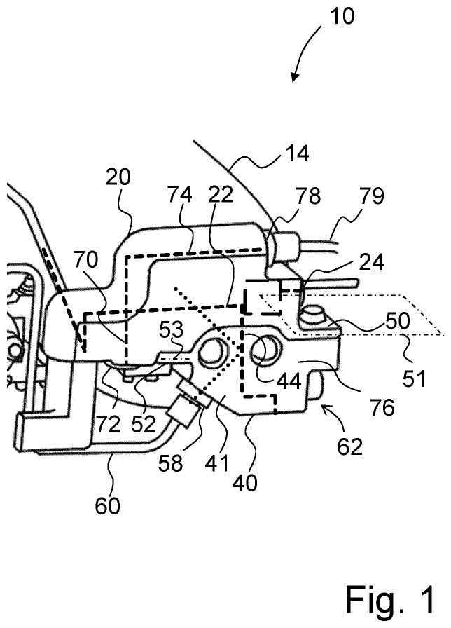

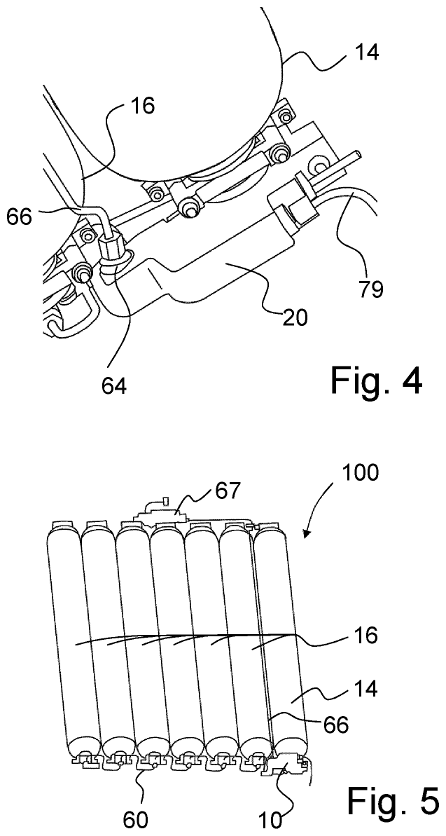

FIGS. 1 to 4 show a valve assembly 10 for a pressure vessel system 100, illustrated in FIG. 5, for a motor vehicle 200, wherein the pressure vessel system 100 is provided for storing pressurized fuel. The pressure vessel system 100 contains a plurality of pressure vessels including a (first) pressure vessel 14 as well as a plurality of (second) pressure vessels 16. As is shown in FIG. 1, the valve assembly 10 (in particular a connection component 40 of the valve assembly 10, which will be explained in more detail hereunder) is installed directly on the first pressure vessel 14 and is spaced apart from the second pressure vessel 16.

The valve assembly 10 comprises a valve body 20 which is designed as a valve block and per se is produced without joints (presently from a metallic solid block, for example from a metal alloy). Moreover, the valve assembly 10 comprises the connection component 40 which has a main body 76 and is likewise produced without joints, and in the present case from a metallic solid block, for example a metal alloy, like the valve body 20. In other words, the main body 76 is also designed as a valve body/valve block. The valve body 20 and the first portion 41 of the connection component 40 have the same thickness in terms of a main plane H of the first portion 41. Formed in the valve body 20 is, inter alia, a first fuel line 22. Moreover, a plurality of functional sub-assemblies which are described in detail hereunder can be provided on the valve body 20. A shut-off valve 24 is disposed on the first fuel line 22 and is specified to be able to close the first fuel line 22 if required, for example during maintenance of the pressure vessel system 100.

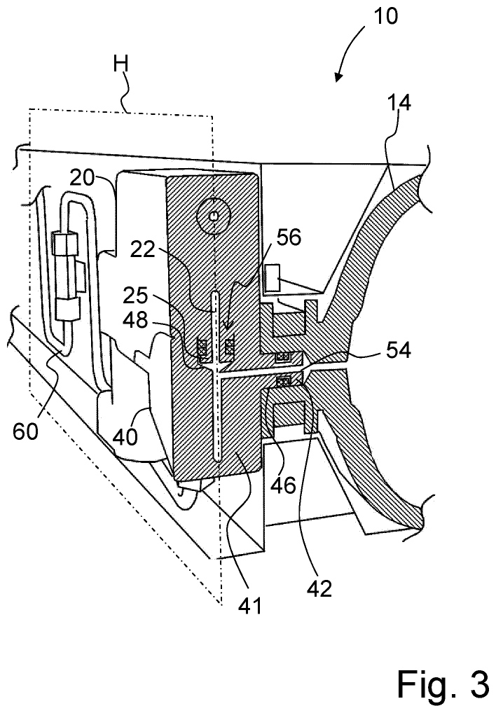

The connection component 40, in particular the main body 76, has a first portion 41 which contacts (directly or indirectly) the valve body 20. A second portion 42 of the connection component 40 is designed as a first port and extends into the first pressure vessel 14. What is mentioned hereunder in the context of the first port thus applies in an analogous manner in general to the second portion 42. When viewed in detail, the first port extends from a surface of the first portion 41 that faces the first pressure vessel 14 in the direction of the first pressure vessel 14. A main direction of extent (longitudinal direction) of the first port (and of the first pressure vessel 14) herein extends as visualized in FIG. 3, substantially perpendicularly to a main plane H of the first portion 41. The first port is designed to be substantially cylindrical, whereby the cylinder axis extends in the longitudinal direction.

The connection component 40 in functional terms serves as an adapter between the valve body 20 and the first pressure vessel 14, and is therefore fastened in each case to the first pressure vessel 14 and to the connection component 40 by a form-fitting and/or force-fitting connection. Proximal to the pressure vessel, the second portion 42/the first port comprises a thread 46 (in particular an external thread) by way of which the connection component 40 screwed into the first pressure vessel 14. For this purpose, the first pressure vessel 14, in particular on its boss, has a thread (in this case an internal thread) which corresponds to the thread 46 of the second portion 42.

The second fuel line 44, which is formed in the connection component 40, extends axially through the first port. This second fuel line 44 not only penetrates the second portion 42, but also the first portion 41, and opens into the first fuel line 22 at a boundary between the first main body 76 and the valve body 20. In this way, the second fuel line 44 in the intended use permanently connects an interior region of the pressure vessel 14, provided for storing the fuel, fluidically to the first fuel line 22. Between a first end 54 foot of the second fuel line 44 in the second portion 42, and a second end 56 of the second fuel line 44 in the first portion 41, the second fuel line 44 bends orthogonally in such a way that the latter on the first end 54 extends in a different direction than on the second end 56. This makes it possible to dispose the valve group 10 in comparatively tight installation spaces at axial ends of the first pressure vessel 14. A groove for sealing the second fuel line 44 in the first port in relation to the environment of the valve assembly 10 is formed along the circumference of the first port. An O-ring is provided in the groove; a (cylindrical) support ring for supporting the O-ring in the groove can additionally be disposed.

In contrast, the connection component 40 is flanged to the valve body 20, in particular by way of a threaded connection; this means that the valve body 20 is connected to the connection component 40 by way of at least one flange. Since this connection is also of a force-fitting/form-fitting, but not materially integral, type, the valve body 20 can be removed from the connection component 40, in particular from the first portion 41, in a non-destructive manner. This opens up new freedoms in the maintenance of the valve assembly 10 according to the present technology. The flange connection comprises a first flange 50 which is formed on the valve body 20, and a second flange 52 which is formed on the connection component 40. Main planes 51, 53 of the first, or the second flange 50, 52, respectively, extend as is indicated in FIG. 1, (substantially) parallel to one another. Through-bores are formed in the first and the second flange 50, 52. The screws that penetrate the through-bores are screwed into the connection component 40 (on the first flange 50), or into the valve body 20 (on the second flange 52), respectively, so as to be mutually anti-parallel.

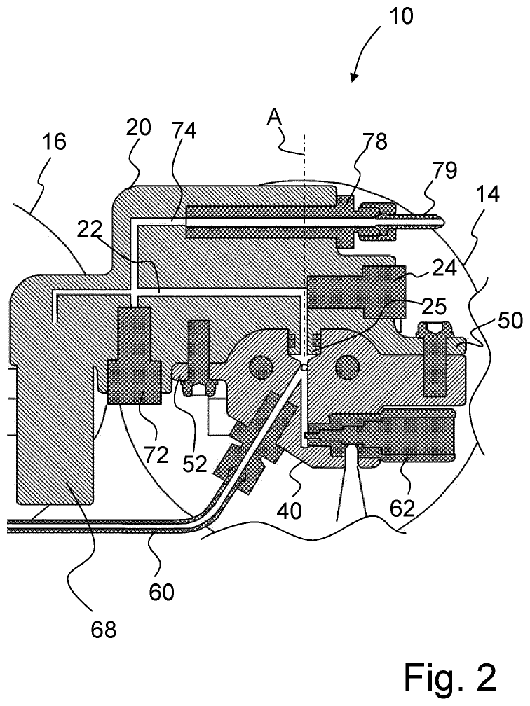

In order to seal a fluidic connection between the connection component 40 and the valve body 20 as efficiently as possible, a second port 25 through which the first fuel line 22 extends is formed on the valve body 20. The connection component 40 contains a receptacle 48 which corresponds to the second port 25 and in which the second port 25 is received in a sealing manner. A longitudinal axis A of the second port 25 herein extend substantially perpendicularly to the main planes 51, 53 of the first and second flanges 50, 52 (cf. FIG. 2). Therefore, the screw axes of the above-mentioned screws are advantageously aligned so as to be parallel to the longitudinal axis A. As opposed to the first port, the second port is designed without a thread. Otherwise, the second port has the features of the first port. In particular, the second port is also of a cylindrical design and contains a groove which extends along the circumferential face of the latter and in which an additional O-ring and optionally an additional support ring is/are provided.

The connection component 40 serves de facto for connecting the valve assembly 10 to the first pressure vessel 40, and for conducting the fuel into and out of the pressure vessel 40 to a distributor line 60 and to a thermal pressure relief device 62. Accordingly, the connection component 40 comprises a connector 58 for a distributor line 60, the connector 58 being fluidically connected to the second fuel line 44. Moreover, a thermal pressure relief device 62, which is fluidically connected to the second fuel line 44, is incorporated in the main body 76 of the connection component 40.

A filling connector 78, the shut-off valve 24, a retrieval connector 64, a solenoid valve 68, and a discharge valve 72 are formed on the valve body 20. A line routing between these valves, or the connectors, respectively, is illustrated dashed and dotted lines in FIG. 1. The shut-off valve 24 is a valve to be activated manually, and is specified to establish a fuel flow through the first fuel line 22, and between the connection component 40 and the valve body 20. This valve, which is to be activated manually, is normally open during the use of the pressure vessel system 100. The shut-off valve 24 can be closed so as to fluidically isolate the first pressure vessel 14 and the second pressure vessels 16 from the retrieval connector 64.

The filling connector 78 is fluidically connected to the first fuel line 22 by way of a fuel filling path 74, wherein the first fuel line 22 forms part of the fuel filling path 74. The fuel filling path 74 accordingly extends from a filling connector 78 on the valve body 20 to the connection component 40, and is able to be blocked by way of the shut-off valve 24. Moreover, a check valve, which according to the intended use prevents a return flow of the fuel from the valve body 20 in to a filling line 79 connected to the filling connector 78, is provided on the filling connector.

The retrieval connector 64 is provided for connecting a fuel retrieval line 66 to an end of the fuel line 22 that lies opposite the connection component 40. In order to increase the efficiency in terms of installation space, the retrieval connector 64 is designed in such a way that the fuel retrieval line 66 on the side of the first pressure vessel 14 extends away from the valve body 20, preferably so as to be substantially parallel to the main direction of extent of the first port. The retrieval line 66 fluidically connects the valve assembly 10 with a fuel supply system of the motor vehicle 200, for example with a pressure reducer 67 (see FIG. 5). In order to control a fuel retrieval flow (mass flow) through the retrieval connector 64, the solenoid valve can be disposed on the retrieval flow path between the shut-off valve 24 and the retrieval portion 64.

Furthermore, a fuel discharge path 70 can branch off from the first fuel line 22 in the direction of a discharge valve 72 upstream of the solenoid valve and downstream of the shut-off valve 24. This means that a fuel discharge path 70, by way of which the first fuel line 22 is fluidically connected to a discharge valve 72 for discharging fuel into the environment of the valve body 20, is formed in the valve body 20.

As is illustrated in FIG. 5, the pressure vessel system 100 contains the one first pressure vessel 14 as well as a plurality of, in the present case six, second pressure vessels 16. The first pressure vessel 14 and the second pressure vessels 16 are aligned parallel to one another in such a way that their longitudinal axes lie in one plane. The pressure vessels 14, 16, by way of their boss, are fixed to a frame construction which can be seen in FIG. 3 and is at least in portions clamped between the valve assembly 10 and a dome of the first pressure vessel 14. While the first pressure vessel 14 is fluidically connected to the connection component 40 by way of the direct engagement, the fluidic connection between the valve body and the second pressure vessels 16 takes place by way of the distributor line 60. This means that the fuel retrieval path for retrieving fuel from the second pressure vessel 16 extends, in the following sequence, by way of the distributor line 60 into the connection component 40, through the second fuel line 44 and through the first fuel line 22 into the fuel retrieval line 66. The entire pressure vessel system 100 of the motor vehicle 200 advantageously contains only one valve assembly 10 described herein, so as to be produced as cost-effectively as possible.

Moreover, the pressure vessel system 100 has all features of the valve assembly 10 which have been described above in the context of FIGS. 1 to 4.

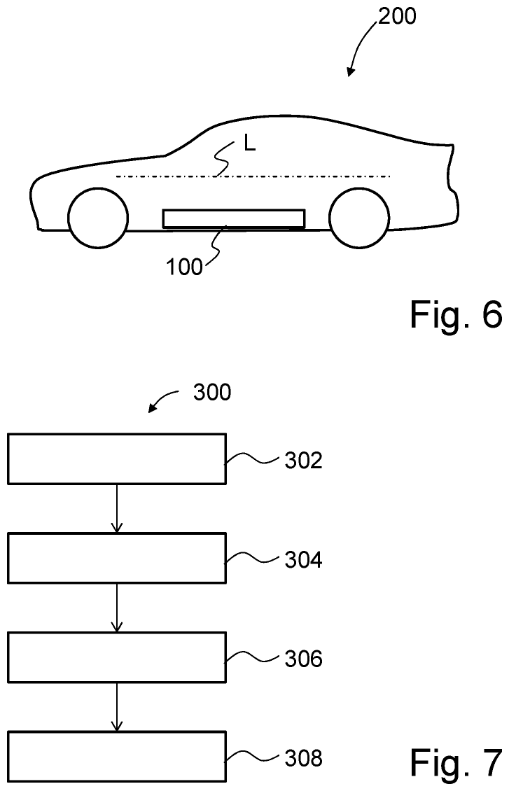

The pressure vessel system 100 is provided for assembling in an underfloor space of a motor vehicle 200 shown in FIG. 6 (presently a passenger motor vehicle), between a front axle of the motor vehicle and a rear axle of the motor vehicle. The pressure vessel system 100 herein can be aligned in such a way that the longitudinal axis of the first pressure vessel 14 extends transversely to the vehicle longitudinal direction L. In this way, the valve assembly 10 is preferably disposed between the first pressure vessel 14 and a door sill of the motor vehicle 200. Moreover, the motor vehicle 200 has all features of the pressure vessel system 100 which have been described above in the context of FIG. 4.

FIG. 7 finally shows a production method 300 for the pressure vessel system 100. In this production method 300, at least the first pressure vessel 14 is first provided in a step 302. Thereafter, the connection component 40 is installed on the first pressure vessel 14 (step 304). The first pressure vessel 14 is subjected to a safety check (step 306), in which the first pressure vessel 14 having the connection component 40 installed thereon, but without the valve body 20, is pressurized (from the inside). Upon completion of the safety check, the valve body 20 can then be connected to the connection component 40 (step 308), in particular screwed to the connection component 40.

For reasons of readability, the term “at least one” has been partially omitted in a simplifying manner. If a feature of the technology disclosed herein is described in the singular or with an indefinite article (for example, the/a fuel line, the/a shut-off valve, etc.), a plurality thereof is also intended to be disclosed at the same time (for example, the at least one fuel line, the at least one shut-off valve, etc.). The term “substantially” in the context of the technology displaced herein comprises in each case the exact characteristic, or the exact numerical value, and variations which are in each case irrelevant to the function of the property/value. At least in portions presently means in portions or completely.

The preceding description of the present invention serves only for illustrative purposes and not for the purposes of restricting the invention. Different amendments and modifications are possible within the context of the invention, without departing from the scope of the invention and its equivalents.

1-16. (canceled)

17. A valve assembly for installation on a pressure vessel, the valve assembly comprising:
a valve body having a first fuel line; and
a connection component having a first portion and a second portion;
wherein the valve body is fastened to the first portion in a non-destructive manner,
wherein the second portion, in an installed state of the valve assembly on the pressure vessel, is specified to protrude at least in portions into the pressure vessel, and
wherein a second fuel line formed in the connection component extends through the first portion and the second portion and, in the installed state of the valve assembly on the pressure vessel, is disposed for the purpose of fluidically connecting an interior region of the pressure vessel to the first fuel line.

18. The valve assembly according to claim 17, wherein the valve body is screwed to the connection component, and/or
wherein the valve assembly has a shut-off valve on the first fuel line, the shut-off valve being configured for closing the first fuel line.

19. The valve assembly according to claim 17, wherein the first portion of the connection component has a main plane, and
wherein the second component of the connection component is formed as a first port extending away from the first portion transversely to the main plane.

20. The valve assembly according to claim 19,
wherein the first port comprises a thread whereby the connection component in the installed state is screwed into the pressure vessel.

21. The valve assembly according to claim 17,
wherein formed on the valve body is a second port, the first fuel line extending therethrough, and
wherein the connection component has a receptacle corresponding to the second port and in which the second port is received in a sealing manner.

22. The valve assembly according to claim 21,
wherein the valve body is fastened to the connection component by a flange formed on the valve body or on the connection component, and
wherein a longitudinal axis of the second port extends transversely to a main plane of the flange.

23. The valve assembly according to claim 17,
wherein the second fuel line has a first end in the first portion, and a second end in the second portion, the first end being disposed so as to be closer to the valve body than the second end, and
wherein the second fuel line on the first end extends in a first direction, and on the second end extends in a second direction, the first direction and the second direction being different.

24. The valve assembly according to claim 17,
wherein the connection component has a connector for a distribution line, the connector being fluidically connected to the second fuel line.

25. The valve assembly according to claim 17,
wherein the connection component is provided with a thermal pressure relief device which is fluidically connected to the second fuel line.

26. The valve assembly according to claim 17, further comprising:
a retrieval connector for a fuel retrieval line on an end of the first fuel line opposite to the connection component, and
wherein a solenoid valve is provided on the first fuel line and is configured to establish fuel flow through the retrieval connector for the fuel retrieval line.

27. The valve assembly according to claim 17,
wherein formed in the valve body is a fuel discharge path fluidically connecting the first fuel line to a discharge valve for discharging fuel into an environment of the valve body.

28. The valve assembly according to claim 17,
wherein formed in the valve body is a fuel filling path extending from a filling connector of the valve body to the connection component.

29. The valve assembly according to claim 17,
wherein the valve body and the first portion of the connection component are of identical thickness at least in portions.

30. The valve assembly according to claim 17,
wherein the valve body and/or a main body of the connection component are/is formed without joints.

31. A pressure vessel system for a motor vehicle, comprising
at least one pressure vessel; and
at least one valve assembly according to claim 17 installed on the pressure vessel.

32. The pressure vessel system according to claim 31,
wherein a number of the pressure vessels is at least two, and wherein the valve assembly is installed on a first one of the pressure vessels, and
wherein a second one of the pressure vessels is fluidically connected to the connection component by means of a distribution line connected to the connection component.

33. A motor vehicle having a pressure vessel system according to claim 31.

34. A production method for a pressure vessel system according to claim 31, the method comprising:
providing the at least one pressure vessel;
installing the connection component on the pressure vessel;
carrying out a safety check on the pressure vessel; and
after the safety check, connecting the valve body to the connection component.
